(19) United States
(12) Patent Application Publication
(10) Pub. No.: US 2014/0074837 A1
(43) Pub. Date: Mar. 13, 2014

(54) ASSIGNING KEYPHRASES

(71) Applicant: APPLE INC., Cupertino, CA (US)

(72) Inventors: Christopher John Sanders, San Jose, CA (US); Amandeep Jawa, San Francisco, CA (US)

(73) Assignee: Apple Inc., Cupertino, CA (US)

(21) Appl. No.: 13/623,071

(22) Filed: Sep. 19, 2012

Related U.S. Application Data
(60) Provisional application No. 61/699,283, filed on Sep. 10, 2012.

(51) Int. Cl. G06F 17/30

(52) U.S. Cl. 707/736; 707/E17.005

(57) ABSTRACT

Disclosed are systems, methods, and non-transitory computer-readable storage media for improving features that are made available to users for navigating through libraries of media items, searching for media items, and organizing groups of media items for consumption. An exemplary method includes receiving a user-tagged keyphrase for a media item from a plurality of media libraries, determining that the user-tagged keyphrase meets a predefined criterion, and sending a command to a selected media library to associate the keyphrase with the media item.

### CROSS REFERENCE TO RELATED APPLICATIONS

This application claims the benefit of U.S. Provisional Patent Application No. 61/699,283, entitled “ASSIGNING KEYPHRASES”, filed on Sep. 10, 2012, which is hereby expressly incorporated herein by reference in its entirety.

### BACKGROUND

1. Technical Field

The present disclosure relates to assigning keyphrases to items.

2. Introduction

Media player applications are commonly used for purchasing, downloading, storing, playing, and organizing digital media items in a user's library. However, as music libraries grow, users can have a difficult time organizing and navigating through their media files to find a media item that they want to consume.

Some attempted solutions for organizing media items involve manually creating playlists of media items. FIG. 1 illustrates an exemplary media player playlist. Despite the advantages of playlists, the process of manually building playlists can be extremely tedious. Additionally, some users group media items in a variety of different ways; therefore, some media items can occur in more than one playlist. Consequently, recommender systems based on playlists and systems for correlating co-concurrence of media items in multiple users' playlists will receive inconsistent inputs and output inconsistent results.

Some other attempted solutions for organizing a group of media items include displaying a list of all media items and by filtering and ordering media items vertically in the list by associated metadata. FIG. 2 illustrates an exemplary media player media item collection that is filtered by “genre”. However, this approach to organizing media items is inadequate because users do not necessarily want to consume media items sequentially simply because those media items share common metadata. For example, wedding goers might want to hear the song “White Wedding” by Billy Idol; however, they may not want to hear an entire playlist of Billy Idol songs played sequentially based on common “Artist” metadata.

As explained herein, improved systems, methods, and computer-readable media are needed to improve the features made available to users for navigating through libraries of media items, searching for media items, and organizing groups of media items for consumption.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for improving features that are made available to users for navigating through libraries of media items, searching for media items, and organizing groups of media items for consumption.

Some embodiments of the present technology involve receiving a user-tagged keyphrase for a media item from a subset of media libraries from among a collection of media libraries and determining that the user-tagged keyphrase meets a predefined criterion. Upon determining that the user-tagged keyphrase meets the predefined criterion, a command is sent to all of the media libraries in the collection of media libraries to associate the keyphrase with the media item.

Some embodiments of the present technology involve determining if a size of the subset of media libraries from which the user-tagged keyphrase is over a predetermined threshold, determining that a number of user-tagged keyphrases for a media item meets predefined threshold, or determining that a predetermined acceleration in the receipt of the user-tagged keyphrase is met.

Some embodiments of the present technology involve determining if the user-tagged keyphrase for a media item is located in a predetermined percentile of a distribution including all of the user-tagged keyphrases received for the media item. Some embodiments also involve filtering a user-tagged keyphrase from the plurality of user-tagged keyphrases based on rules dictating that a user-tagged keyphrase matching an existing metadata value for the media item is filtered from the distribution, rules dictating that a user-tagged keyphrase containing a proper name is filtered from the distribution, and rules dictating that a user-tagged keyphrase containing profanity is filtered from the distribution.

Some embodiments of the present technology involve associating an operator-tagged keyphrase and keyphrase meeting a criterion with the media item in a database of media items. Some embodiments involve sending a command to all of the media libraries in the collection of media libraries to associate updated keyphrases with the media item.

Some embodiments of the present technology involve sending a command to all of the media libraries in the collection of media libraries to truncate an amount of keyphrases used in association with a media item by truncating operator-tagged keyphrases and keyphrases that meet the predefined criterion in favor of updated operator-tagged keyphrases and updated keyphrases that meet the predefined criterion, but not truncating user-tagged keyphrases.

Some embodiments of the present technology involve using keyphrases to search an online store. Some embodiments of the present technology involve using keyphrases to sort media items. Some embodiments of the present technology involve using keyphrases along with a recommender system to recommend media items. Some embodiments of the present technology involve using keyphrases along with an invitational content system to serve invitational content.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary media player playlist;

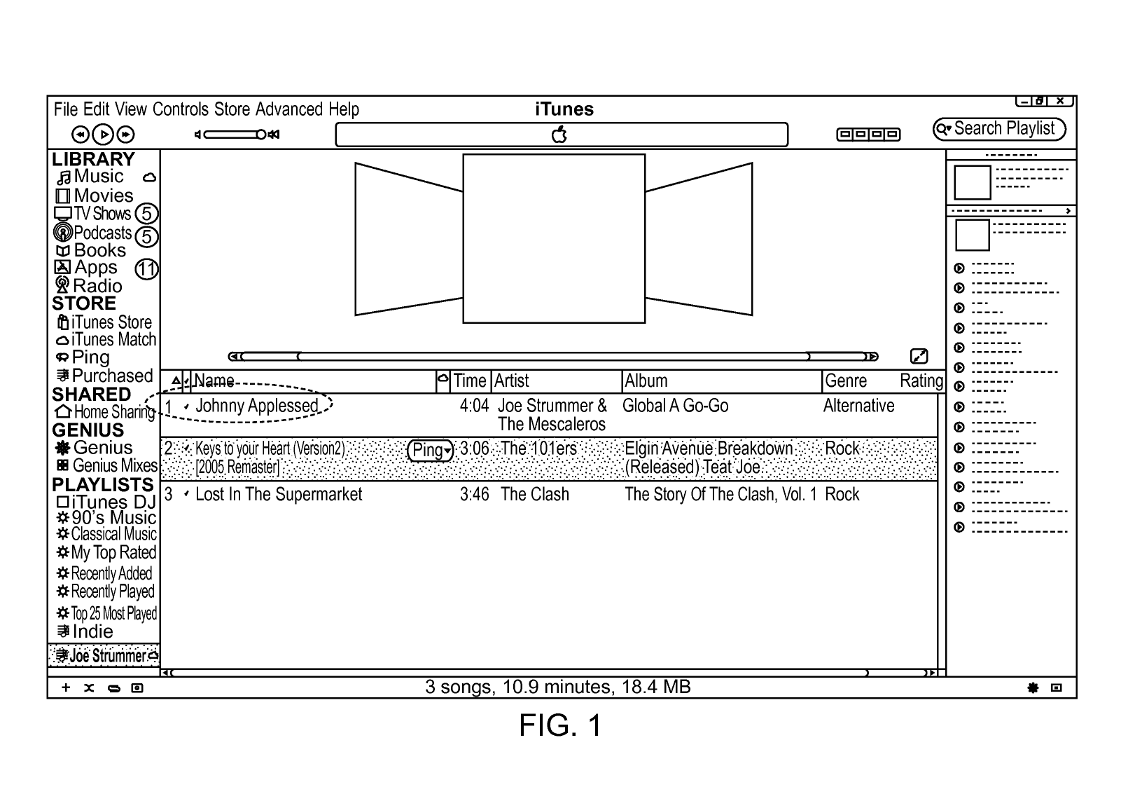

FIG. 2 illustrates an exemplary media player media item collection that is filtered by metadata;

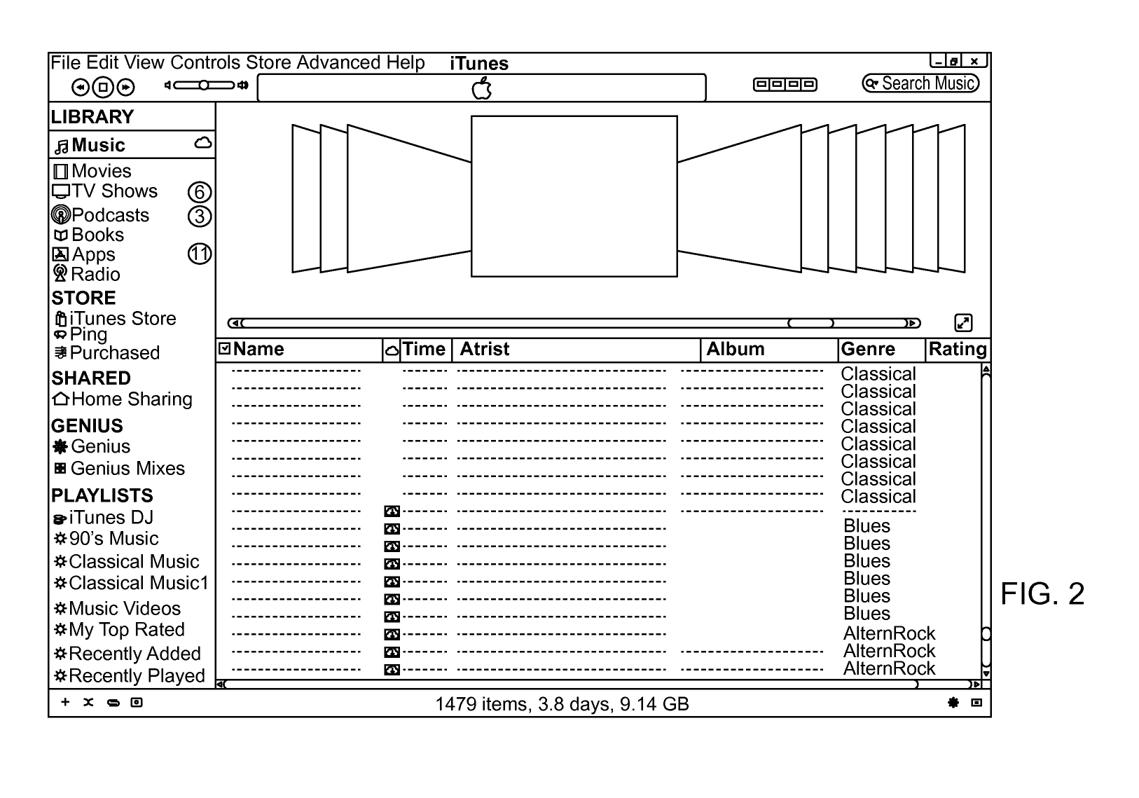

FIG. 3 illustrates a media player application interface with menus for users to tag media items with keyphrases according to some embodiments of the present technology;

FIG. 4 illustrates another exemplary interface with menus for users to tag media items with keyphrases according to some embodiments of the present technology;

FIG. 5 illustrates an interface with a menu for organizing media by keyphrase according to some embodiments of the present technology;

FIG. 6 illustrates an exemplary system for analyzing user-tagged keyphrases and pushing keyphrases that meet a predetermined criterion or operator-defined keyphrases from a network-based media distribution platform to client devices according to some embodiments of the present technology;

FIG. 7 illustrates an exemplary method of analyzing user-tagged keyphrases and pushing keyphrases that meet a predetermined criterion back to client devices by a server-based media platform according to some embodiments of the present technology;

FIG. 8 illustrates a method of updating keyphrases according to some embodiments of the present technology; and

FIG. 9 illustrates an exemplary computer system according to some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for improved media item navigation. A system, method and non-transitory computer-readable media are disclosed which improve on features that allow users to navigate through libraries of media items and organize groups of media items for consumption.

Some embodiments of the present technology involve users tagging media items with keyphrases that capture consumers' thoughts and feeling about media items. A keyphrase can include single or multiple words, partial words, acronyms, abbreviations, or emoticons including alphabetic characters, diacriticals, numerals, symbols, ideograms, or other glyphs that can convey meaning about media in a way that cannot be accomplished by traditional metadata or that can otherwise serve as delineators. In some ways, keyphrases act as metadata; however, unlike traditional metadata, keyphrases can be subjective, free-form, non-uniform for various users, etc. Although the term keyphrase is used herein, one of ordinary skill in the art having the benefit of this disclosure can utilize the disclosed technology with any way of allowing users to assign additional data to a media file.

Some embodiments of the present technology involve using keyphrases to organize media. In the case of tagging digital music files, keyphrases can be used to organize music files into meaningful groups.

In some embodiments, users can tag music files with keyphrases that imply a feeling associated with listening to a song or sentiment felt when the user first heard the song or at another time which left an emotional imprint. For example, users can tag music files as “happy,” “sad,” “inspired,” “depressed,” etc. In some embodiments, users can tag media files with tags independent from a song's original style, meaning, etc. For example, a user might tag a song as “romantic,” not because the song itself is a romantic song, but because it was the song playing when something romantic happened in the user's life.

In some embodiments, users can tag music files with situational keyphrases that describe situations that can be associated with the music. For example, users can tag music files as “exercise,” “cooking,” “snowboarding,” “romantic music,” “wedding,” etc. In a more particular example, a user can tag Pachelbel's “Cannon in D” with the keyphrase “wedding” to connote that it is a song often heard at weddings. A user may also tag The Village People's “YMCA” with the keyphrase “wedding” to provide the same connotation. Consequently, organizing a collection of music by keyphrase will group Pachelbel's “Cannon in D” with The Village People's “YMCA.”

In some embodiments users can tag music files with a place or context in which they heard a song. For example a user can tag Fleetwood Mac's original version of “Landslide” with the keyphrase “Glee” after hearing the cast of the television show Glee perform a cover of the song. In another example, a user can tag a song with “college” to establish an association between the song and his college memories.

In some embodiments users can tag music files with characteristics about the song incapable of being captured with known standard metadata definitions. For example, a song might be tagged as instrumental. By itself “instrumental” is not a genre because multiple genres can include instrumental songs. In another illustrative example, a media item can be tagged with an instrument that is highlighted in that song, e.g. “drum solo.”

In some embodiments, user-tagged keyphrases can overlap. For example, a track tagged with “exercise” could also be tagged with “happy,” or “The Biggest Loser.”

Although specific examples of tags, tag types, and keyphrases are mentioned explicitly, those with ordinary skill in the art having the benefit of this disclosure will readily appreciate that a wide variety of keyphrases can be used as tags to provide media items with a wide variety of descriptions, connotations, etc.

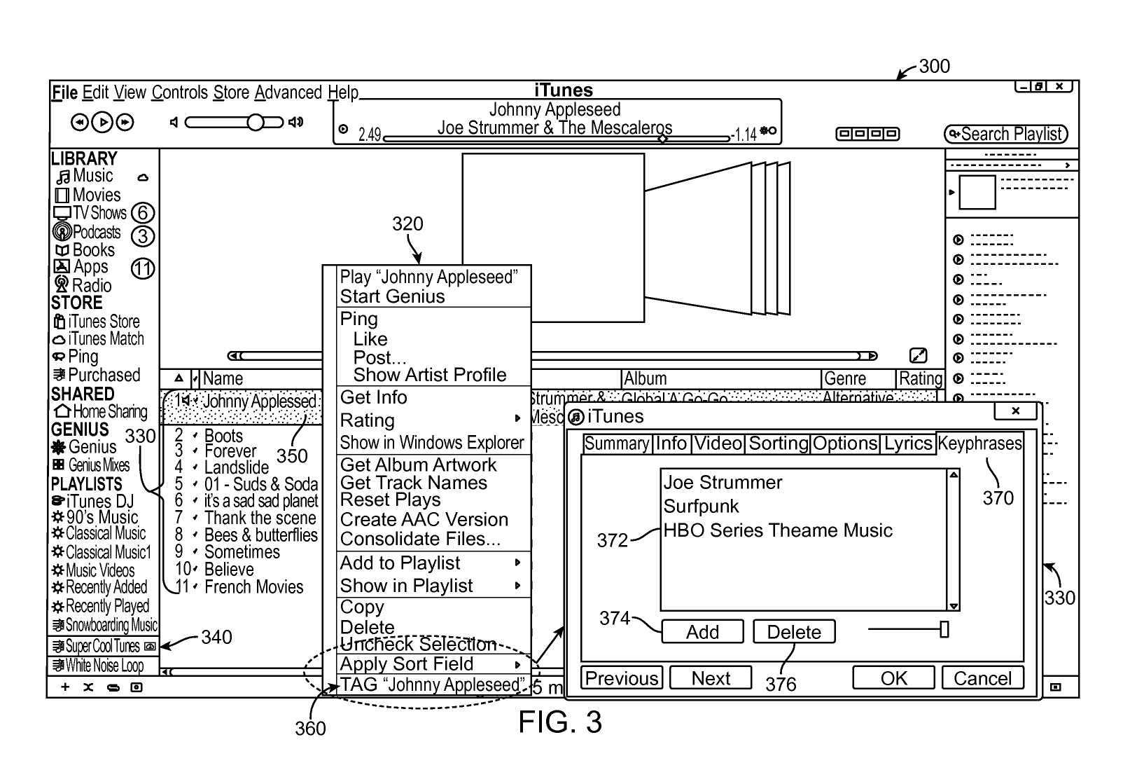

Some embodiments of the present technology involve interfaces and tools for allowing users to tag media items with keyphrases. FIG. 3 illustrates a media player application interface 300 with menu 320 that allow users to tag media items with keyphrases according to some embodiments of the present technology. As illustrated in FIG. 3, the media player application interface 300 displays a set 330 of media items contained in a playlist 340. Interacting with a media item 350 from the set 330 of media items can bring up a menu 320 containing a plurality of commands including a “Tag” command 360. In some embodiments, interacting with the “Tag” command brings up another menu 330 with a “Keyphrases” tab 370. In the “Keyphrases” tab, a user can view current tagged keyphrases for the media item 350 in a viewing pane, add 374 new tags for the media item 350, and delete 376 tags for the media item 350.

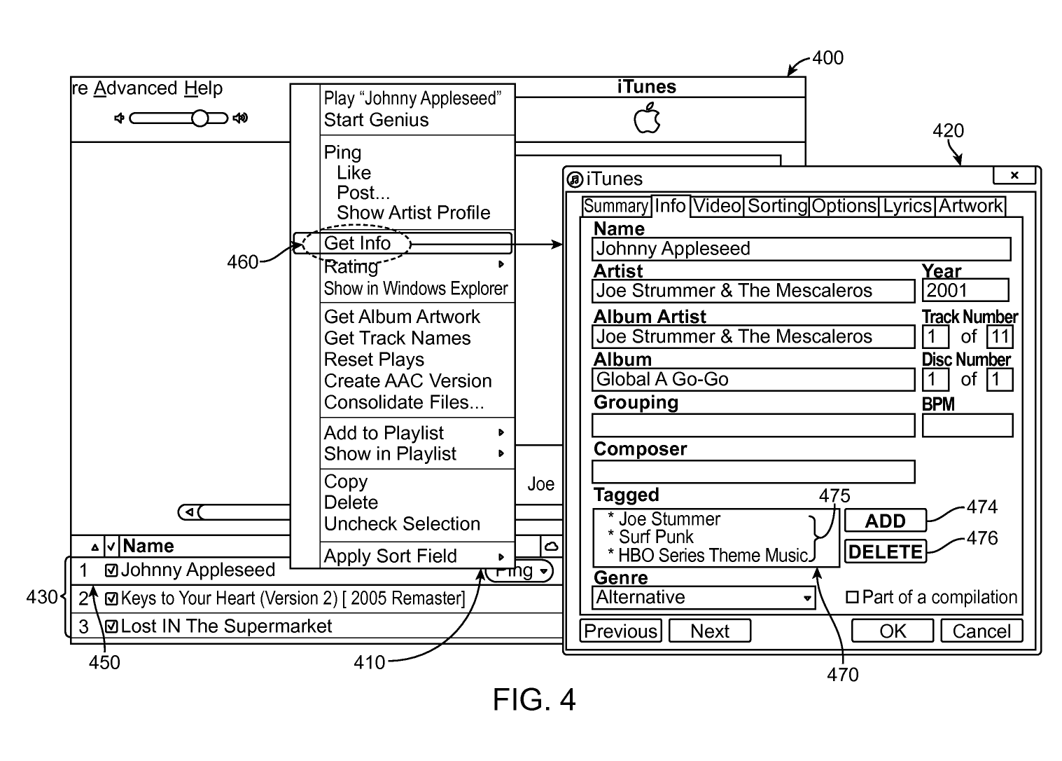

FIG. 4 illustrates another exemplary interface 400 with menus 410, 420 that allow users to tag media items with keyphrases according to some embodiments of the present technology. As illustrated in FIG. 4, the media player application interface 400 displays a set 430 of media items contained in a playlist. Interacting with a media item 450 from the set 430 of media items can bring up a menu 420 containing a plurality of command including a “Get Info” command 460. In some embodiments, interacting with the “Get Info” command brings up another menu 430 with an “Info” tab. In the “Info” tab, a user can view and change some traditional metadata fields as well as view a pane 470 listing a set 475 of currently tagged keyphrases for the media item 450, add 474 new tags for the media item 450, and delete 476 tags for the media item 450.

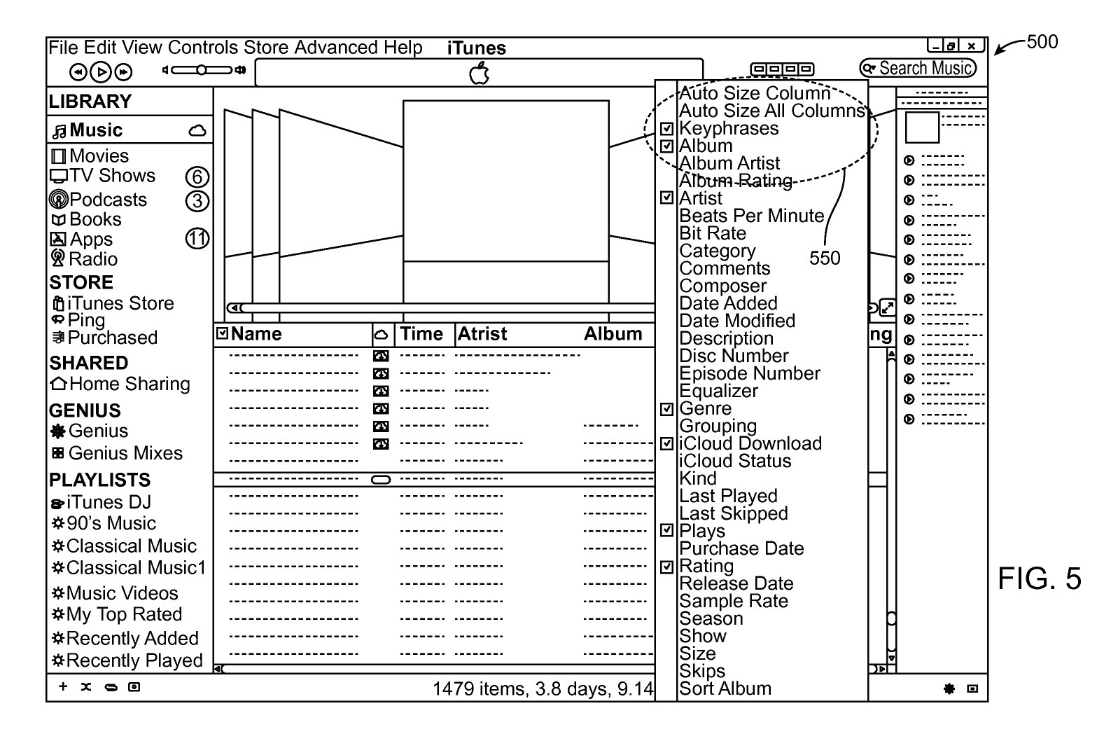

As explained above, keyphrases can allow users to organize media items. FIG. 5 illustrates an interface 500 with a menu 550 for organizing media by keyphrase according to some embodiments of the present technology.

As explained herein, some embodiments of the present technology involve users tagging their own media items with keyphrases. In some embodiments, users' self-tagged keyphrases are augmented with analyzed keyphrases or operator-defined keyphrases. Some embodiments of the present technology also involve a media platform pushing keyphrases that have been associated with a media item by other users or by a system operator.

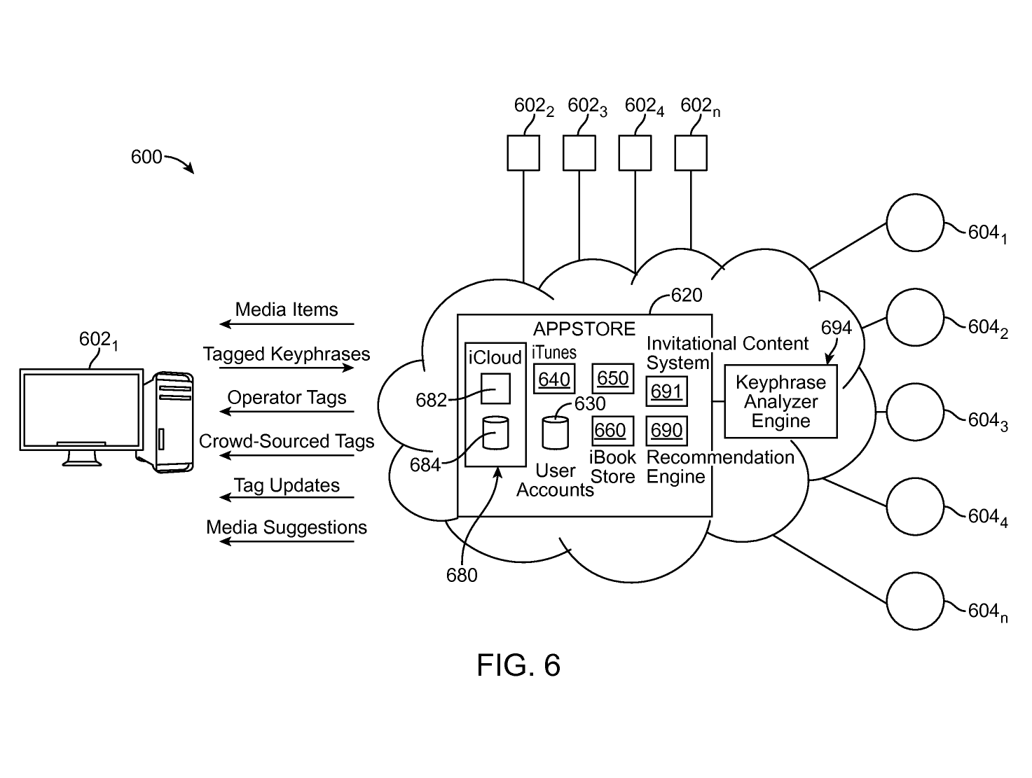

FIG. 6 illustrates an exemplary system 600 for analyzing user-tagged keyphrases and pushing keyphrases that meet a predetermined criterion or operator-defined keyphrases from a network-based media distribution platform to users according to some embodiments of the present technology.

The system 600 of FIG. 6 includes a network-based media platform 620 including one or more processing modules configured for performing the present technology as broadly disclosed herein. In some embodiments of the present technology, the media platform 620 includes one or more media distribution systems 640, 650, 660 associated with a database 630 of user accounts. In some embodiments of the present technology, the one or more media distribution system includes a media distribution and management system 640, such as the iTunes® store, available from Apple Inc. of Cupertino, Calif.

In some embodiments of the present technology, the one or more media distribution system includes an eBook distribution and management system 660, such as iBookstrore^{SM}, available from Apple Inc. of Cupertino, Calif. In some embodiments of the present technology, the one or more media distribution system includes an application distribution and management system 650, such as App Store^{SM}, available from Apple Inc. of Cupertino, Calif.

In some embodiments of the present technology, the media platform 620 also includes a cloud storage component 680, such as iCloud™, available from Apple Inc. of Cupertino, Calif. In some embodiments, the cloud storage component 680 includes a processing module 682 and a storage component 684.

In some embodiments of the present technology, the media platform 620 also includes a media item recommendation system 690, such as Genius®, available from Apple Inc. of Cupertino, Calif. In some embodiments of the present technology, the media platform 620 also includes an invitational content system 691, such as iAd®, available from Apple Inc. of Cupertino, Calif.

The media platform 620 is operatively coupled with a plurality of computing devices 602₁, 602₂, 602₃, 602₄, . . . , 602ₙ which include a media player computer program client used for playing, downloading, saving, and organizing digital media items, such as an iTunes® client for computers and mobile devices, available from Apple Inc. of Cupertino, Calif.

The media platform 620 is also operatively coupled with a plurality of media item providers 604₁, 604₂, 604₃, 604₄, . . . , 604ₙ which upload media content, applications, updates, etc. to the media platform 620. The media platform 620 facilitates the sale, rent, license, etc. of the media content and tenders the providers 604₁, 604₂, 604₃, 604₄, . . . , 604ₙ with a portion of a payment. In some embodiments of the present technology, the media item providers provide metadata embedded in the digital media items. For example, digital music content oftentimes includes metadata relating to artist, album, genre, track name, etc. In some embodiments of the present technology, an operator of the media platform 620 can tag the media items with keyphrases before they are sold, rented, or licensed and transferred to a computing device. In some embodiments, operator-added keyphrases help users find the media items that they are looking for or serve to introduce users to the concepts and benefits of keyphrase tagging.

As illustrated in FIG. 6, users of a computing device can obtain media items from the one or more media distribution systems 640, 650, 660. In some embodiments, the computing devices 602₁, 602₂, 602₃, 602₄, . . . , 602ₙ obtain media items from other sources. In some embodiments, a media player client application installed on the computing device associates downloaded media with one or more user account and stores a library of media items associated with the user account on the computing device. In some embodiments, the media player client application associates media obtained from other sources with a user account and stores information about the media obtained from other sources in a library associated with the user account. Additionally, in some embodiments, the media player client application is configured to allow users to tag media items with keyphrases, as explained above. In some embodiments, the media platform 620 is configured for uploading user-tagged keyphrases from media player client application on the computing devices 602₁, 602₂, 602₃, 602₄, . . . , 602ₙ to the media platform 620. Before uploading user-tagged keyphrases, the media platform 620 can be required to receive user consent of a privacy policy. A more detailed explanation of privacy policies is discussed below.

In some embodiments, an operator of the media platform 620 tags media items with keyphrases. In some embodiments, the uploaded user-tagged keyphrases and the operator-tagged keyphrases are stored in a keyphrase database 692.

In some embodiments of the present technology, the media platform 620 also includes a keyphrase analyzer engine 694 configured for analyzing keyphrases which are tagged and uploaded from users (referred to as a “collective set” of keyphrases) and configured for detecting one or more keyphrases associated with a media item that meet a predetermined criterion. In some embodiments, the predetermined criterion can include one or more numerical or statistical analysis on the collective set of keyphrases to determine what keyphrases are most frequently used, what keyphrases are currently most popular, what keyphrases are experiencing most growth in usage, etc.

For example, in some embodiments, all user-tagged keyphrases associated with a particular media item are arranged in a distribution and the keyphrase analyzer engine 694 determines if the user-tagged keyphrase is located in a predetermined percentile of the distribution. In another example, the keyphrase analyzer engine 694 determines if the user-tagged keyphrase meets a predetermined acceleration in the receipt of the user-tagged keyphrase from the subset of media libraries. In another example, the keyphrase analyzer engine 694 determines if a size of the subset of media libraries from which the user-tagged keyphrase is tagged is over a predetermined threshold.

In some embodiments, the keyphrase analyzer engine 694 performs one or more filtering function before determining if the user-tagged keyphrase is located in a predetermined percentile of a distribution. For example, some users will tag media items with keyphrases already described in existing metadata, e.g. tagging a Jazz song with the keyphrase “jazz.” In these cases, the keyphrase analyzer engine 694 can filter keyphrases that describe a genre from the collective set of keyphrases.

Also, the keyphrase analyzer engine 694 can filter user-tagged keyphrases containing a proper name. In another example, some users will tag media items with people's names, e.g. “Chris's Music.” To the user, “Chris's Music” might help the user organize his music, but “Chris's Music” may not help anyone else organize music. Accordingly, the keyphrase analyzer engine 694 can filter out the “Chris's Music” tag from a collective set of keyphrases.

In some embodiments, the keyphrase analyzer engine 694 can filter user-tagged keyphrases that contain profanity, describe violence, include hate speech, include sexually-explicit content, etc.

In some embodiments of the present technology, the keyphrase analyzer engine 694 is also configured for forming a subset of keyphrases for each media item that can be best used to organize the media item in users' playlists, as determined by the statistical analysis and filtering. The keyphrase analyzer engine 694 is also configured for sending the keyphrases back to the computing devices 602₁, 602₂, 602₃, 602₄, . . . , 602ₙ that meet a predetermined criterion.

In some embodiments of the present technology, tag updates and media suggestions based on keyphrases are sent to the computing devices 602₁, 602₂, 602₃, 602₄, . . . , 602ₙ from the media platform 620.

Some embodiments of the present technology involve methods for receiving a user-tagged keyphrase for a media item from a subset of media libraries from among a collection of media libraries and determining if the user-tagged keyphrase meets a predefined criterion. Upon determining that the user-tagged keyphrase meets the predefined criterion, a command is sent to all of the media libraries in the collection of media libraries to associate the keyphrase with the media item.

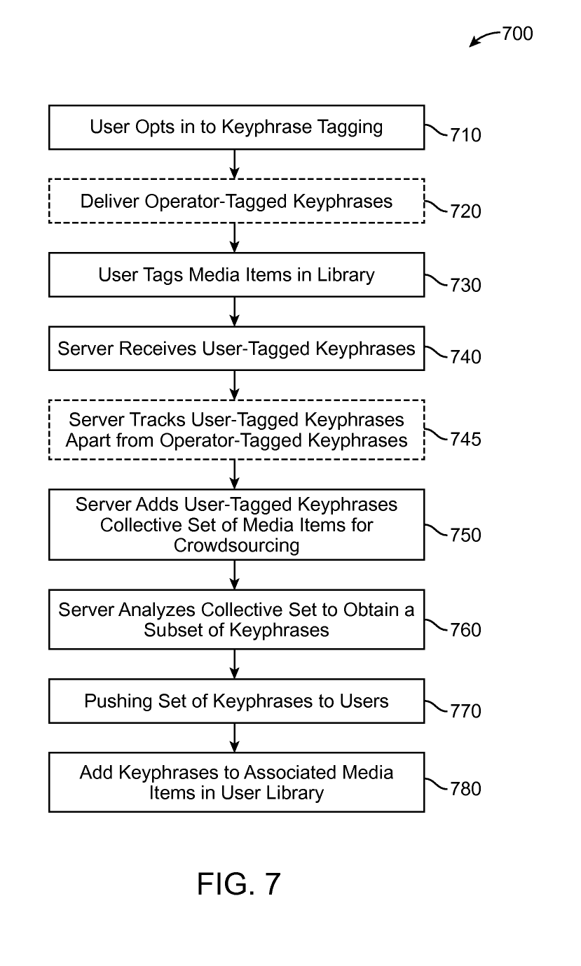

FIG. 7 illustrates an exemplary method 700 of receiving user-tagged keyphrases and pushing keyphrases that meet a predetermined criterion back to client devices by a server-based media platform according to some embodiments of the present technology. The method 700 illustrated in FIG. 7 involves a user opting in 710 to a keyphrase tagging and server-side keyphrase pushing system. In some embodiments of the present technology, opting in to a keyphrase tagging and server-side keyphrase pushing system involves informing the user of a privacy policy and receiving an indication of user consent.

In some embodiments of the present technology, the method optionally delivers 720 operator-tagged keyphrases upon the user opting in to using keyphrases. The operator-tagged keyphrases are used to orient a user on how keyphrase tagging works and on how to organize and search for media items using keyphrases.

Next, a user tags 730 his own media items with keyphrases and the server receives 740 user-tagged keyphrases associated with media items. In some embodiments of the present technology, the server pulls user-tagged keyphrases from client applications. In some embodiments, pulling is automatically performed periodically, e.g. one per week. In some embodiments, the client device pushes user-tagged keyphrases to the server. In some embodiments, the user pushes keyphrases associated with media items each time the user requests that the media player client application match his media library with the cloud-based storage component of the server-based media distribution system. The server optionally tracks 745 user-tagged keyphrases differently than operator-tagged keyphrases.

Upon the server receiving user-tagged keyphrases, the server adds 750 the user-tagged keyphrases to a collective set of keyphrases for each media item. Next, the server analyzes 760 the collective sets of keyphrases based on a predetermined criterion to obtain a subset of keyphrases that are determined to be the most common, most popular, trending, etc.

In some embodiments of the present technology, only the user-tagged keyphrases are analyzed for a predetermined criterion. However, some embodiments involve analyzing both user-tagged keyphrases and operator-tagged keyphrases.

Next, the keyphrases meeting a predetermined criterion are pushed 770 to all users who have opted in to the media distribution system's keyphrase tagging service. Upon receiving the key phrases, users' client applications automatically add 780 keyphrases to the media items that they are associated with. Although this example involves a media distribution system pushing keyphrases to client applications, one of ordinary skill in the art having the benefit of this disclosure will appreciate that any method of transferring keyphrases can benefit from the present technology. For example, client applications can be configured with a command to pull keyphrases from a media distribution platform.

Keyphrases that people frequently associate with media items can change over time. For example, if a song is featured in a popular movie or television program, users might begin to associate the song with the movie or television show. In a more specific example, suppose the television show “Glee” performs a rendition of Fleetwood Mac's “Landslide”. After the episode of Glee airs, users may begin to tag the original version of the song with “Glee,” despite the fact that the original version was not featured on the episode.

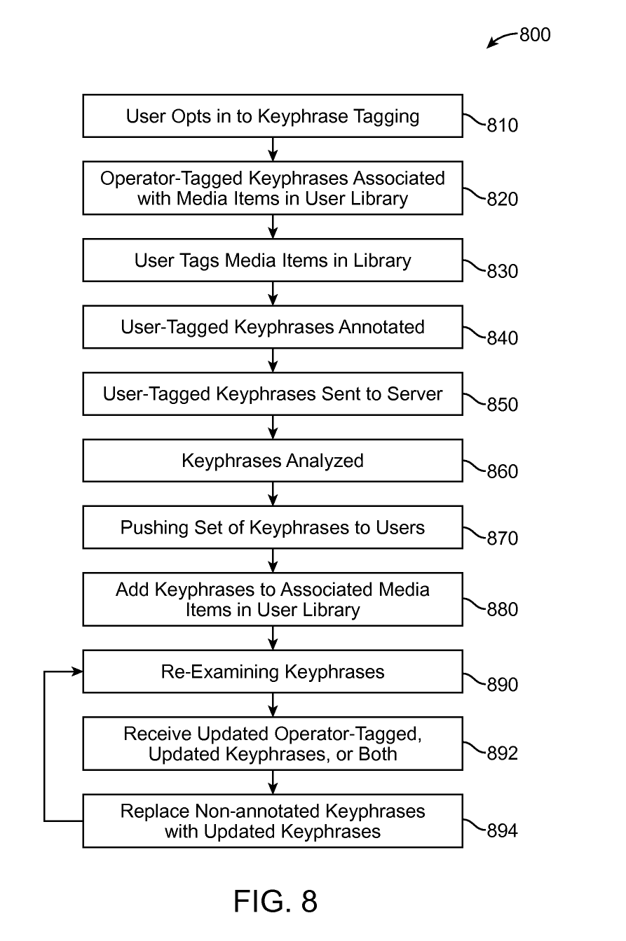

To accommodate changing associations with media items, some embodiments of the present technology involve updating users' keyphrases. FIG. 8 illustrates a method 800 of updating keyphrases according to some embodiments of the present technology.

The method 800 illustrated in FIG. 8 involves a user opting in 810 to a keyphrase tagging and server-side keyphrase pushing system and associating 820 operator-tagged keyphrases with media items in a user's library of media items. Next, in some embodiments a user tags 830 media items in his library with keyphrases and user-tagged keyphrases are annotated 840 to connote user authorship as opposed to operator-tagged keyphrases or analyzed keyphrases. The user-tagged keyphrases are sent 850 to the server and a collective set of users' keyphrases are analyzed for a predetermined criterion 860.

Next, the keyphrases that meet a predetermined criterion are pushed 870 to users who have opted in to the media distribution system's keyphrase tagging service and added 880 to the media items that they are associated with.

Over time, the results of analysis on the collective set of user-tagged keyphrases changes based on evolving user associations with the media items. Consequently, the method 800 involves periodically re-analyzing 890 keyphrases. In some embodiments, re-analyzing keyphrases involves reexamining whether a predetermined criterion is met, filtering new phrases from a set of keyphrases, checking for updates to a set of operator-tagged keyphrases, etc. The re-examination results in updated keyphrases being sent to and received 892 by the client device. Next, the client application replaces 894 keyphrases with the updated keyphrases. In some embodiments of the present technology, keyphrases that are annotated as user-tagged keyphrases are not replaced by updated keyphrases, but operated-tagged keyphrases and keyphrases sent because they meet a predetermined criterion are updated.

As explained above, keyphrases are very useful in organizing a media library. Additionally, keyphrases provide added utility in a number of other ways, such as searching for media items and recommending other media items to users.

In some embodiments of the present technology, a media item recommendation system uses keyphrases to analyze a user's taste and recommend other media items to the user in which they might like. In some embodiments, users' taste data can be used to recommend invitational content such as promotions or advertisements for goods or services that the user might be interested in.

In some embodiments of the present technology, a media player can be configured to search for media items using keyphrases. For example, using an example from above, a search using “wedding” as a search term can result in a list of media items tagged with “wedding” such as Pachelbel's “Cannon in D,” The Village People's “YMCA,” and “White Wedding” by Billy Idol. Likewise, following another example from above, a user searching for “Glee” can result in the system displaying Fleetwood Mac's original version of “Landslide.”

As explained above, some embodiments of the present technology involve the keyphrase analyzer engine 694 only examining user-tagged keyphrases. In some embodiments, the keyphrase analyzer engine 694 performs an individual analysis for users and only examines keyphrases tagged by a user's connections in a social media platform. In some embodiments only examines keyphrases tagged by users in a certain geographical area or nation.

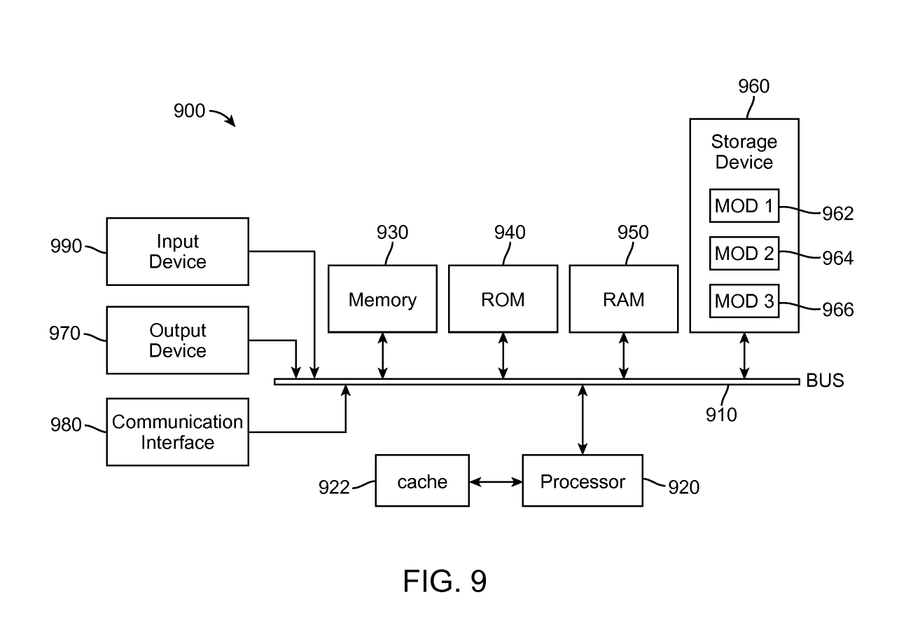

The systems, methods, and computer-readable media described above can be employed in a variety of ways known to those with ordinary skill in the art having the benefit of this disclosure; however, a brief description of a basic general purpose system or computing device in FIG. 9 can provide an example of how to practice the concepts disclosed herein.

With reference to FIG. 9, an exemplary system 900 includes a general-purpose computing device 900, including a processing unit (CPU or processor) 920 and a system bus 910 that couples various system components including the system memory 930 such as read only memory (ROM) 940 and random access memory (RAM) 950 to the processor 920. The system 900 can include a cache of high speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 160 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 920, bus 910, display 970, and so forth, to carry out the function. The basic components are known to those of skill in the art and appropriate variations are contemplated depending on the type of device, such as whether the device 900 is a small, handheld computing device, a desktop computer, or a computer server.

Although the exemplary embodiment described herein employs the hard disk 960, it should be appreciated by those skilled in the art that other types of computer readable media which can store data that are accessible by a computer, such as magnetic cassettes, flash memory cards, digital versatile disks, cartridges, random access memories (RAMs) 950, read only memory (ROM) 940, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 920. The functions these blocks represent may be provided through the use of either shared or dedicated hardware, including, but not limited to, hardware capable of executing software and hardware, such as a processor 920, that is purpose-built to operate as an equivalent to software executing on a general purpose processor. For example the functions of one or more processors presented in FIG. 9 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 940 for storing software performing the operations discussed below, and random access memory (RAM) 950 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 900 shown in FIG. 9 can practice all or part of the recited methods, can be a part of the recited systems, and/or can operate according to instructions in the recited non-transitory computer-readable storage media. Such logical operations can be implemented as modules configured to control the processor 920 to perform particular functions according to the programming of the module. For example, FIG. 9 illustrates three modules Mod1 962, Mod2 964 and Mod3 966 which are modules configured to control the processor 920. These modules may be stored on the storage device 960 and loaded into RAM 950 or memory 930 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

As described herein, one aspect of the present technology is the gathering and use of data available from various sources to improve the delivery of invitational content including, promotions, advertisements, or any other content that may be of interest to users. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data in the present technology can be used to the benefit of users. For example, the personal information data can be used to better understand user behavior, facilitate and measure the effectiveness of advertisements, applications, and delivered content. Accordingly, use of such personal information data enables calculated control of the delivered content. For example, the system can reduce the number of times a user receives a given ad or other content and can thereby select and deliver content that is more meaningful to users. Such changes in system behavior improve the user experience. Further, other uses for personal information data that benefit the user are also contemplated by the present disclosure.

The present disclosure further contemplates that the entities responsible for the collection, analysis, disclosure, transfer, storage, or other use of such personal information data should implement and consistently use privacy policies and practices that that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after the informed consent of the users. Additionally, such entities would take any needed steps for safeguarding and securing access to such personal information data and ensuring that others with access to the personal information data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for advertisement delivery services. In yet another example, users can configure their devices or user terminals to prevent storage or use of cookies and other mechanisms from which personal information data can be discerned. The present disclosure also contemplates that other methods or technologies may exist for blocking access to their personal information data.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving a user-tagged keyphrase for a media item from a plurality of media libraries;
determining that the user-tagged keyphrase meets a predefined criterion; and
sending a command to a selected media library to associate the keyphrase with the media item.

2. The method of claim 1, wherein determining that the user-tagged keyphrase meets a predefined criterion comprises determining that a number of the plurality of media libraries from which the user-tagged keyphrase is received is over a predetermined threshold.

3. The method of claim 1, wherein determining that the user-tagged keyphrase meets a predefined criterion comprises determining that a predetermined acceleration in the receiving of the user-tagged keyphrase in the plurality of media libraries is met.

4. The method of claim 1, wherein determining that the user-tagged keyphrase meets a predefined criterion comprises determining that the user-tagged keyphrase for the media item is located in a predetermined percentile of a distribution comprising a plurality of user-tagged keyphrases received for the media item.

5. The method of claim 1, wherein determining that the user-tagged keyphrase meets a predefined criterion comprises determining that user-tagged keyphrase does not match an existing metadata value for the media item.

6. The method of claim 1, wherein determining that the user-tagged keyphrase meets a predefined criterion comprises determining that user-tagged keyphrase does not contain a proper name.

7. The method of claim 1, wherein determining that the user-tagged keyphrase meets a predefined criterion comprises determining that user-tagged keyphrase does not contain profanity.

8. The method of claim 1, wherein determining that the user-tagged keyphrase meets a predefined criterion comprises determining that a number of user-tagged keyphrases describing the media item meets a predefined threshold.

9. The method of claim 1, further comprising:
maintaining a database of media items; and
upon determining that the user-tagged keyphrase meets the predefined criterion associating the keyphrase with the media item in the database of media items.

10. The method of claim 9, further comprising:
receiving an instruction by an operator of a media distribution system to associate a media item with an operator-tagged keyphrase; and
associating the operator-tagged keyphrase with the media item in the database of media items.

11. The method of claim 10, further comprising:
receiving updated operator-tagged keyphrases, updated keyphrases that meet the predefined criterion, or both updated operator-tagged keyphrases and updated keyphrases that meet the predefined criterion; and
sending a command to the selected media library to associate the updated operator-added keyphrases and updated keyphrases that meet the predefined criterion with the media item.

12. The method of claim 11, further comprising:
sending a command to the selected media library to truncate an amount of keyphrases used in association with a media item by:
truncating operator-tagged keyphrases and keyphrases that meet the predefined criterion in favor of the updated operator-tagged keyphrases and updated keyphrases that meet the predefined criterion.

13. A system comprising:
a network-based media distribution system operatively coupled with a client device having a client media player application and a library of media items; and
a keyphrase module configured to:
receive a user-tagged keyphrase for a media item from a plurality of media libraries;
determine that the user-tagged keyphrase meets a predefined criterion, wherein the network-based media distribution system is configured to: push the keyphrase meeting the predetermined criterion to the client device; and
associate the keyphrase meeting the predetermined criterion with a media item.

14. The system of claim 13, wherein the keyphrase module is further configured to:
determine that a number of libraries in the plurality of media libraries from which the user-tagged keyphrase is received is over a predetermined threshold;
determine that a number of user-tagged keyphrases for the media item meets predefined threshold;
determine that a predetermined acceleration in the receiving of the user-tagged keyphrase is met; and
determine that the user-tagged keyphrase for the media item is located in a predetermined percentile of a distribution comprising all user-tagged keyphrases received for the media item.

15. The system of claim 14, wherein the keyphrase module is further configured to:
filter from the distribution, a user-tagged keyphrase from a plurality of user-tagged keyphrases based on one or more rules selected from among a group of rules consisting of:
rules dictating that a user-tagged keyphrase matching an existing metadata value for the media item is filtered from the distribution;
rules dictating that a user-tagged keyphrase containing a proper name is filtered from the distribution; and
rules dictating that a user-tagged keyphrase containing profanity is filtered from the distribution.

16. A non-transitory computer-readable medium comprising:
a medium configured to store computer-readable instructions thereon; and
the computer-readable instructions that, when executed by a processing device cause the processing device to perform a method, comprising:
receiving a user-tagged keyphrase for a media item from a plurality of media libraries;
determining that the user-tagged keyphrase meets a predefined criterion; and
sending a command to a selected media library to associate the keyphrase with the media item.

17. The non-transitory computer-readable storage medium of claim 16, the instructions further comprising:
maintaining a database of media items; and
associating the keyphrase with the media item in the database of media items.

18. The non-transitory computer-readable storage medium of claim 16, the instructions further comprising:
associating an operator-tagged keyphrase with the media item in a database of media items.

19. The non-transitory computer-readable storage medium of claim 18, the instructions further comprising:
receiving updated operator-tagged keyphrases, updated keyphrases that meet the predefined criterion, or both updated operator-tagged keyphrases and updated keyphrases that meet the predefined criterion; and
sending a command to the selected media library to associate the updated operator-added keyphrases and updated keyphrases that meet the predefined criterion with the media item.

20. The non-transitory computer-readable storage medium of claim 19, the instructions further comprising:
sending a command to the selected media library to truncate an amount of keyphrases used in association with a media item by:
truncating operator-tagged keyphrases and keyphrases that meet the predefined criterion in favor of the updated operator-tagged keyphrases and updated keyphrases that meet the predefined criterion.

21. A method comprising:
obtaining a media item on a client device;
tagging the media item with a user-tagged keyphrase;
associating the user-tagged keyphrase with the media item; and
transmitting the user-tagged keyphrase to a media distribution platform configured to determine that the user-tagged keyphrase meets a predefined criterion, and to associate the user-tagged keyphrase with a collective set of keyphrases for the media item that meets the predefined criterion.

22. The method of claim 21, further comprising:
sending a request to the media distribution system to recommend a further media item, wherein the media distribution system uses a keyphrase from a further collective set of keyphrases to recommend further media items; and
receiving a further media item based on a recommendation.

23. The method of claim 21, further comprising:
requesting invitational content from a media distribution platform, wherein the media distribution platform uses a keyphrase in association with an invitational content module to select invitational content; and
receiving invitational content from the media distribution platform.

24. A method comprising:
receiving a user-tagged keyphrase for a media item from a media library;
aggregating the received keyphrase with a group of substantially matching stored keyphrases to form an aggregation of keyphrases;
determining that the aggregation of substantially matching keyphrases meets a predefined criterion; and
sending a command to a selected media library to associate a keyphrase from the aggregation of substantially matching keyphrases with the media item.

25. The method of claim 24, wherein determining that the aggregation of substantially matching keyphrases meets a predefined criterion comprises determining that a size of the aggregation of substantially matching keyphrases is over a predetermined threshold.

26. The method of claim 24, wherein determining that the aggregation of substantially matching keyphrases meets a predefined criterion comprises determining that a predetermined acceleration in the receiving of the user-tagged keyphrase in the aggregation of substantially matching keyphrases is met.

27. The method of claim 24, wherein determining that the aggregation of substantially matching keyphrases meets a predefined criterion comprises determining that the aggregation of substantially matching keyphrases is located in a predetermined percentile of a distribution comprising all user-tagged keyphrases received for the media item.

28. The method of claim 24, further comprising:
maintaining a database of media items; and
upon determining that aggregation of substantially matching keyphrases meets the predefined criterion associating a keyphrase from the aggregation of substantially matching keyphrases with the media item in the database of media items.
